(19) United States
(12) Patent Application Publication
(10) Pub. No.: US 2013/0026321 A1
(43) Pub. Date: Jan. 31, 2013

(54) KICK PLATE

(71) Applicants: Robert Richardson, Owosso, MI (US); John C. Main, Vernon, MI (US); Jeffrey R. Swanson, Flint, MI (US)

(72) Inventors: Robert Richardson, Owosso, MI (US); John C. Main, Vernon, MI (US); Jeffrey R. Swanson, Flint, MI (US)

(21) Appl. No.: 13/550,572

(22) Filed: Jul. 16, 2012

Related U.S. Application Data
(60) Provisional application No. 61/572,342, filed on Jul. 14, 2011.

(51) Int. Cl. F16M 13/00

(52) U.S. Cl. 248/235

(57) ABSTRACT

A kick plate for a base bracket of a shelving unit, comprising an elongated panel having longitudinal and vertical axes, and an imaginary plane substantially coincident with the panel, and a substantially L-shaped member projecting from an end of the panel and integral with the panel, the L-shaped member having a longitudinal axis substantially parallel to the panel vertical axis, the L-shaped member further having a distal end extending further from the plane than the horizontal surfaces past the nominal width of the panel, wherein the distal end has a lip, wherein the lip removably attaches the panel to the shelving unit after the L-shaped member is inserted into the base bracket of the shelving unit, wherein the panel is removably attachable to the base bracket.

### CROSS-REFERENCE TO RELATED APPLICATIONS

This original utility patent application is based on and claims priority to U.S. Provisional Patent Application No. 61 572,342, filed on Jul. 14, 2011. Provisional Patent Application No. 61 572,342 is incorporated herein by reference in its entirety.

### TECHNICAL FIELD

The invention relates to plates installed within brackets that are typically, but not necessarily, at the bottom of shelving units.

### SUMMARY OF THE INVENTION

The invention includes a one-piece kick plate for a shelving unit, comprising an elongated plastic panel; an attachment device integrally molded at each end of the panel; the attachment device having a resilient, L-shaped member with a lip for removably attaching the panel to the lower portion of the shelving unit; the panel being removable for cleaning or replacement; the panel being resistant to damage and corrosion; the panel being highly suitable for presenting an advertising message (in a currently underutilized location); the advertising message being easily put on the panel prior to shipping to the retail store, or once it's there.

The invention described herein includes a kick plate (a.k.a. kick panel or toe kick or base front) for the lower portion of a shelving unit (not shown) for items to be displayed. A shelving unit for commercial purposes is typically used to display a number of products for sale to potential customers. Alternatively, a shelving unit may be used for other purposes, such as to display items for easy viewing by the public at a museum, etc. Such display shelving is commonly fabricated of steel with various specifications, thicknesses, grades, strengths, surface treatments and coatings to suit a particular application, as will be understood by persons having ordinary skill in the art. A shelving unit must be designed to have adequate strength to safely support the total load placed upon it, and would typically have a substantial support structure in addition to the necessary shelf or shelves, hangers, etc. This support structure is the frame of the shelving unit, and is usually designed with practical considerations in mind as opposed to the aesthetic appeal to potential customers. Therefore the support structure can be quite utilitarian and unsightly. In the shelving industry it is common to cover or mask this support structure, particularly near the floor of the shelving unit. This improves the overall appearance of the shelving unit. Furthermore, another benefit is to prevent a person's foot from coming too close to the support structure, thus preventing a potential injury to the foot (hence the name “kick plate”—the person's foot kicks the plate instead of going under the first shelf or into the support structure region). Also, since it tends to be difficult to clean under shelf units, a “kick plate” limits the area which must be kept clean to the more-easily accessible portion near the front of the unit.

Kick plates have been fabricated from metals, typically various steels. This has been done in the past because shelving manufacturers have had ready-access to steel (and limits the number of suppliers such manufacturers need to work with). However, metal kick plates tend to be expensive in the current marketplace due to the rising costs to manufacture metals. They tend to oxidize (i.e. rust) over time and become unsightly. Metal kick plates become damaged, bent and deformed over time as they are removed from their shelving units and reinstalled. They tend to come in standard colors, and do not lend themselves to advertising due to the cost of post-fabrication application of advertising information media. Therefore a need has been created for kick plates which are cost-effective to produce, do not rust or become damaged easily and riddled with unsightly “dings,” which are easy to clean as well as resistant to becoming soiled, are made of recyclable material(s) and therefore are ecologically “green,” are available in a wide variety of colors as well as surface textures, patterns, styles and designs, and improve advertising opportunities for merchants. To address these needs, the inventors propose kick plates which are made from various polymers plastics, and having specific design features necessary to the successful use of such polymer kick plates in both new and existing commercial shelving applications.

One embodiment of a kick plate for the lower portion of a shelving unit comprises an elongated polymer panel having a panel height determined by the shelving application, i.e. substantially the distance between the lowest shelf and the floor. Note that it is foreseeable that “kick plates” may also be used in situations a substantial distance away from (i.e. above) the floor, in a stacking arrangement of shelf units which require attaching the units with structural components which are to remain out of the public's view. The elongated polymer panel inherently has longitudinal, lateral and vertical axes (as well as a plane passing through the longitudinal and vertical axes which is substantially coincident with the panel). These inherent characteristics are helpful for relating the various aspects of the panel to its attachment members (described further herein).

At one end, for example a first or left end, of a polymer panel may be at least one connecting attaching attachment device. (The first end may alternatively be defined as the right end of the panel.) This attachment device may be used to retain the kick plate (plate) in its proper position with respect to the shelving unit. The attachment device may extend over substantially the entire height of the panel. In this situation, adjacent panels may substantially meet end-to-end (i.e. butt up next to each other). Alternatively, the attachment device extends for a first portion of the panel height (i.e. part of the panel height). In this situation, the remainder of the portion of the panel height forms a recessed portion or recess in the first end of the panel. This recess may receive an attachment device of an adjacent elongated panel, substantially forming an abutment abutting surfaces interface boundary joint between the panels. The panels may or may not actually touch, and there may or may not be a substantially visible gap between the panels, either as a practical matter or by design, but all of these cases are defined herein as creating or forming an abutment or joint between the panels.

Typically, a panel will include a second attachment device connected to, for example, a second or right end of the panel. (The second end may alternatively be defined as the left end of the panel.) In a similar fashion to the description above for the first portion, the second attachment device may extend for a second portion of the panel height, with a remainder of the second portion forming a recessed portion or recess in the second end of the panel. This recess may receive an attachment device of an adjacent elongated panel to substantially form a joint between the panels as described above. The height of the first and second portions together may substantially equal the panel height. Alternatively, their heights may not be substantially equal the panel height, so that a gap may be created between the adjacent panels at the resulting joint.

The first and second attachment devices may be at opposite vertical ends of the panel (i.e. opposite ends of the panel height). The vertical ends comprise the top and bottom ends or edges of the panel when viewed after installation on a shelving unit. Alternatively, the first and second attachment devices may be at the same vertical end of a panel.

An elongated panel may include at least one stiffening rib. The rib or ribs (plurality of ribs) permit an overall reduction in the amount of plastic material used per piece, by increasing the stiffness strength of the panel while minimizing its nominal thickness. The stiffening ribs may be arranged asymmetrically on an elongated panel. Or they may be arranged symmetrically.

One advantage of the invention is that the attachment device may be integral (formed integrally) with the plastic panel (i.e. a substantially one-piece design). For example, this may be accomplished in substantially one plastic injection molding process, which reduces the “part count” for the kick plate, reducing the fabrication time and cost, and making the manufacturing process more reliable.

Furthermore, the attachment device may be within (or substantially within) the plane formed by coincident with the elongated panel. Whereas the attachment device devices may be offset from the panel (or angled with respect to the panel, or both) for certain applications, the attachment device devices would typically be substantially within the plane for ease of manufacturing. This may facilitate use of a simpler molding die for making the plate. Each attachment device has an attachment device longitudinal axis (a.k.a. device longitudinal axis) which may be substantially parallel to a panel vertical axis. In this configuration, the panels may be substantially perpendicular to the floor after being installed on a shelving unit. However as suggested herein, the invention contemplates alternate designs wherein the longitudinal axis axes of the attachment device devices (a.k.a. connecting device devices) is not substantially parallel to the panel vertical axis, in which cases the plate may be angled toward (or away from) the shelving unit at the bottom of the panel. If the bottom of the plate is angled toward the shelving unit, this would provide some additional room before a person's foot would touch or strike the kick plate (as the person walks up to the unit). If the bottom of the plate is angled away from the shelving unit, this would permit easier viewing by the person of printed information, graphic designs, indicia, drawings, pictures, colors, patterns of colors, surface textures, service marks, trademarks, trade names, business names, product names, product brands and or photographs, etc. on the plate. Note that each of these types of information can also be used for a kick plate wherein the bottom of the plate angles towards the shelving unit, or is substantially perpendicular to the floor or ground.

An attachment member may further comprise a resilient member projecting from a respective end of a panel. The resilient member may form an opening or channel between the resilient member and the panel. The purpose of this resilient member is to partially enclose a portion of the unit support structure by “snapping” over the portion and or frictionally engaging the portion to facilitate attachment of the kick plate to the structure (as well as removal from the structure). One resilient member may be used per plate. Alternatively, two resilient members may be used per plate (one per attachment device) to permit more reliable attachment of the plate at its extremities (for example, the left and right ends). Alternatively, a plurality of resilient members may be used, as well as a plurality of attachment members, in various combinations as suits the particular application. The nominal distance between two resilient members along the longitudinal axis may be selected in order to properly connect to two portions of the shelving unit which provide the necessary attachment points or attachment locations. These points or locations may be comprised of slender, cylindrical rods or tubes of metal, such as steel. Alternatively, each point or location may be comprised of a plurality of rods or tubes, or other individual components of the shelving unit's structure. Alternatively, the points or locations may be selected from the group consisting of cylindrical metal rods, cylindrical metal tubes, steel pins which are substantially normal to the plane of the panel, steel pins which are substantially parallel to the plane of the panel, hooks, square metal stock, rectangular metal stock, and combinations thereof. A channel may receive a substantially cylindrical rod substantially rigidly affixed connected to the shelving unit, wherein the panel may be removably connected to the shelving unit.

To further facilitate attachment and retention of the kick plate to the structure, the resilient member may include a lip. The lip may extend substantially along the entire edge of the attachment member. Alternatively, the lip may extend along a portion of the entire edge. Furthermore, the length of the lip (with reference to the attachment longitudinal axis) may be a selected short length, wherein the lip may be referred to as a lip or a bump or a raised point. Furthermore, the lip may be comprised of a plurality of bumps or raised points along the edge of the attachment member. The lip substantially removably fastens affixes retains attaches the panel to the cylindrical rod after the member has been flexed displaced moved away from the centerline of the rod due to a force applied to the attachment member substantially normal to the plane of the panel. After aligning the resilient member with, for example, the cylindrical rod of the shelving unit and applying the necessary force (by a person's hand or hands or with a tool, such as a rubber mallet), the resilient member will deflect so that the opening of the channel increases to the point that the rod may slide past the lip and into proper position within the channel. Thereafter, the resilient member will substantially return to its original configuration, i.e. with substantially the original channel opening dimension, so as to retain the rod within the channel, which will hold the plate in its proper location on the shelving unit. This combination of elements can be designed to produce a tighter interference or friction “fit” between the channel, L-shaped member, lip and rod. Or the “fit” can be designed with a greater amount of clearance so as to be relatively loose-fitting (and therefore more tolerant of geometric variation in the distance between the rods of the unit). Alternatively, there may be no lip or substantially no lip when the channel is designed to substantially provide a friction-fit between the attachment device and the shelving unit structure. For example, the cross section of the channel may be substantially V-shaped, wherein the shelving structure frictionally communicates (i.e. in frictional communication, or substantially removable communication) with the walls of the opening of the “V.” Alternatively, the walls of the channel may be angled with respect to each other in order to perform this same function, but without necessarily forming a “V” (i.e. similar to a “V” but without the walls making contact at the “point” of the “V”).

The attachment device may also be designed to have a plurality of resilient retaining members, such as a plurality of individual or substantially individual resilient retaining features (for example, a plurality of plastic fingers).

The attachment member may further comprise a resilient, substantially arcuate member projecting from a respective end of a panel.

The attachment member may further comprise a resilient, substantially C-shaped member projecting from a respective end of a panel.

The attachment member may further comprise a resilient, substantially V-shaped member projecting from a respective end of a panel.

The attachment member may further comprise a resilient, substantially L-shaped member projecting from a respective end of a panel. The cross section of the opening of the channel may be substantially rectangular, or substantially square.

The channel may open on the back, i.e. backside, of the panel. In other words, the opening of the channel may face away from the person installing the kick plate as it faces toward the cylindrical rod to which it will be attached.

The panel may be removable for cleaning and reattaching to the shelving unit. Furthermore, the panel may be removable for replacing the panel with a different panel.

The elongated panel may be made of a polymer, plastic, synthetic rubber, glass-reinforced fiber compound material, or other suitable materials or combinations of materials which meet the necessary appearance, weather resistance and cost considerations. As used in this patent application, a polymer may be a material comprising a large molecule (macromolecule) composed of repeating structural units typically connected by covalent chemical bonds. Polymer herein refers to a large class of natural and synthetic materials with a variety of properties, including plastics, synthetic rubber, Bakelite, neoprene, nylon, polyvinyl chloride, polystyrene, polyethylene, polypropylene, polyacrylonitrile, polyvinyl butyral, acrylate-butadiene-styrene (ABS), silicone and other materials. Alternatively, the plastic may utilize recycled paint solids by, for example, blending latex paint solids with high-density polyethylene (HDPE) or polymethyl methacrylate (PMMA). If plastic is used, it may be either a thermosetting or thermoplastic type.

The panel may be selected from the group consisting of polymers and metals.

The member or members may be formed by injection molding.

The panel may be molded or painted in various colors, as best suits the various intended applications. The color may be a neutral color such as, for example, whatever the base color is for the recycled plastic that is used, in order to lower the cost of the final product by eliminating the need for a colorant. The color (and surface texture) may be whatever is suitable for painting according to the preference of the user of the invention.

Alternatively, means for removably attaching the panel may be selected from the group consisting of hook-and-loop fastening materials, snaps, buttons, laces, hooks, laces, wires, pins, safety pins, elastic bands, and combinations thereof.

The invention may include a method of attaching a kick plate to a shelving unit, comprising aligning the channel of an attachment member with a cylindrical rod on the unit support structure, and applying a substantially normal force to the kick plate or panel, wherein a resilient member on the panel is deflected.

The invention may include a method of attaching a kick plate to a shelving unit, comprising, aligning the channel of a first attachment member with a first cylindrical rod on the unit support structure, aligning the channel of a second attachment member with a second cylindrical rod on the unit support structure, resiliently deflecting a first resilient member of the first attachment member connected to the kick plate or panel by applying a substantially normal force to the kick plate or panel, resiliently deflecting a second resilient member of the second attachment member connected to the kick plate or panel by applying a substantially normal force to the kick plate or panel, wherein the panel may be securely removably connected to the cylindrical rods.

The invention further may include a method of advertising or method of communicating information to a person using a kick plate for a shelving unit, comprising applying printed information, graphic designs, indicia, drawings, pictures, colors, patterns of colors, surface textures, service marks, trademarks, trade names, business names, product names, product brands and or photographs, etc. to the panel elongated panel of a kick plate, and attaching the panel to the shelving unit.

The invention further may include a method of advertising or method of communicating information to a person using a kick plate for a shelving unit, comprising applying printed information, graphic designs, indicia, drawings, pictures, colors, patterns of colors, surface textures, service marks, trademarks, trade names, business names, product names, product brands and or photographs, etc. to the panel elongated panel of a kick plate, aligning the channel of a first attachment member with a first cylindrical rod on the unit support structure, aligning the channel of a second attachment member with a second cylindrical rod on the unit support structure, resiliently deflecting a first resilient member of the first attachment member connected to the kick plate or panel by applying a substantially normal force to the kick plate or panel, resiliently deflecting a second resilient member of the second attachment member connected to the kick plate or panel by applying a substantially normal force to the kick plate or panel, wherein the panel elongated panel may be securely removably connected to the cylindrical rods.

The invention further may include a kick plate or kick panel or toe kick or base front for the lower portion of a shelving unit for items to be displayed, comprising an elongated panel having a panel height and panel longitudinal, lateral and vertical axes, the panel further having a plane substantially coincident with the panel; at least one attachment device connected to a first end of the panel; wherein the attachment device extends for a first portion of the panel height, further wherein a first remainder portion of the panel height forms a first recess in the first end of the panel which may receive an attachment device of an adjacent elongated panel, wherein an abutment joint may be substantially formed between the panels at the first end of the panel; a second attachment device connected to a second end of the panel; wherein the second attachment device extends for a second portion of the panel height, further wherein a second remainder portion of the panel height forms a second recess in the second end of the panel which may receive an attachment device of an adjacent elongated panel, wherein an abutment abutting surfaces interface boundary joint may be substantially formed between the panels at the second end of the panel; further wherein the first and second attachment devices may be at opposite vertical ends of the panel; further wherein the first and second attachment devices may be at opposite ends of the panel height; further wherein the panel may include at least one stiffening rib.

### BRIEF DESCRIPTION OF THE DRAWINGS

FIG. 1 is a broken isometric view of an embodiment of kick panels installed in a base plate of a shelving unit.

FIG. 2 is a partially-broken isometric view of the back sides of adjacent kick panels prior to being installed in a shelving unit.

FIG. 3 is a broken elevated view of the ends of a kick panel.

FIG. 4 is a section view taken along line 4-4 in FIG. 2.

FIG. 5 is a section view taken along line 5-5 in FIG. 2.

FIG. 6 is a side view of the right end of the kick panel shown in FIG. 2.

FIG. 7 is a side view of the left end of the kick panel shown in FIG. 2.

FIG. 8 is a top view of a portion of the left L-shaped member of FIG. 3.

FIG. 9 is a top view of a portion of the right L-shaped member of FIG. 3.

FIG. 10 is a broken isometric view of the right portion of the back side of the kick panel of FIG. 2.

FIG. 11 is a broken front view of the front sides of adjacent kick panels prior to being installed in a shelving unit.

### DESCRIPTION OF THE PREFERRED EMBODIMENT

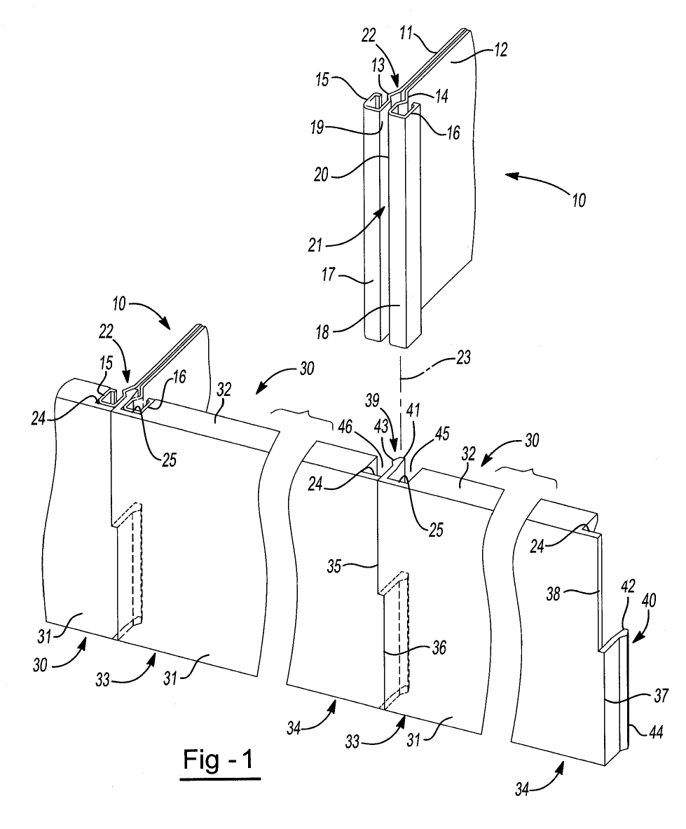

Referring to FIG. 1, a broken isometric view is shown of adjacent kick plates (a.k.a. kick panels) 30 installed in a base plate 10 of a shelving unit (not shown). Each of the base plates shown is comprised of left and right brackets 11, 12, respectively. The brackets are typically stamped out of steel flat stock. Brackets 11, 12, are formed with substantially triangular channels 13, 14 respectively. When the brackets are aligned and welded together they form vertical opening 22 for receiving L-shaped members of adjacent kick panels. Brackets 11, 12, also have left and right U-shaped portions, 15, 16, with outward-facing vertical surfaces 17, 18, respectively. Alternatively, portions 15, 16, do not form U-shapes and instead end with vertical surfaces 17, 18. The U-shaped portions have surfaces, 19, 20, respectively, which together form vertical gap 21 for receiving distal ends of L-shaped members during installation of the kick plates. Longitudinal axis 23 of vertical opening 22 is substantially aligned with lip 43 to facilitate the installation. When installation has been completed (described further herein), the distal ends of respective L-shaped members are substantially located within vertical opening 22 (see base plate 10 at the left side of FIG. 1). Each kick plate 30 is comprised of front face 31 and upper shelf 32. Furthermore, each kick plate has left and right ends 33, 34 respectively. Left end 33 has first height portion 35 and first height remainder portion 36. Right end has second height portion 37 and second height remainder portion 38. Typically, the height of the first and second height portions together substantially equals the panel height. Left and right ends 33, 34, have substantially L-shaped members 39, 40, respectively, projecting from them. The L-shaped members shown in FIG. 1 are integral with kick panels 30. L-shaped members 39, 40, have distal ends 41, 42, respectively, with lips, 43, 44, respectively. The lips facilitate removably attaching and retaining their respective panel to the shelving unit after its L-shaped members are inserted into the base bracket of the shelving unit. L-shaped members 39, 40 form channels 45, 46, respectively, at the ends 33, 34, of the panel. The channels have a substantially rectangular cross section. The channels open toward the back of the panel, and are adaptable for receiving U-shaped portions 15, 16, during assembly of the panel with the base plate.

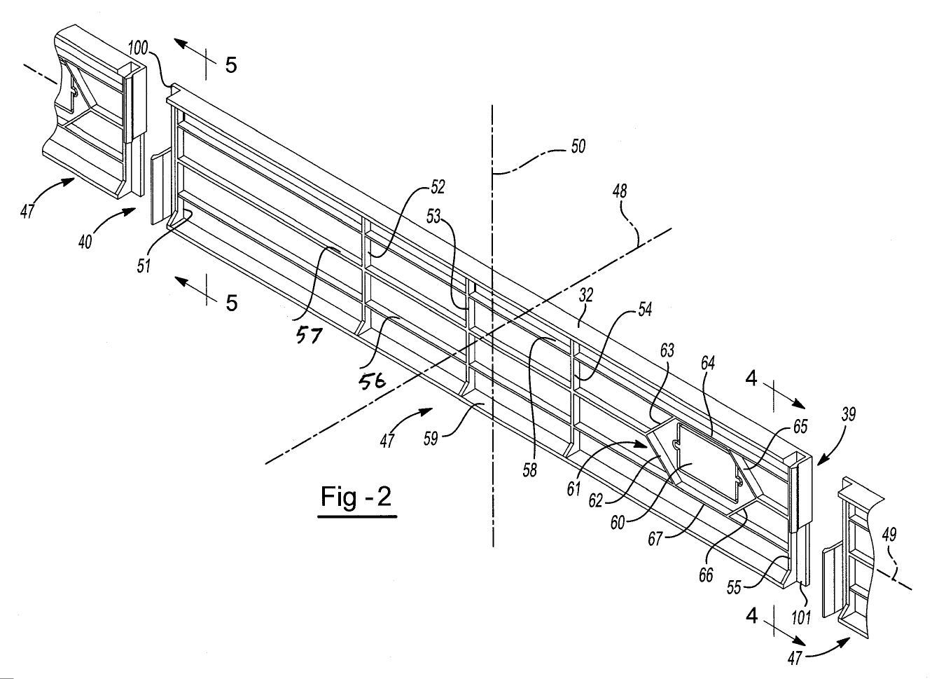

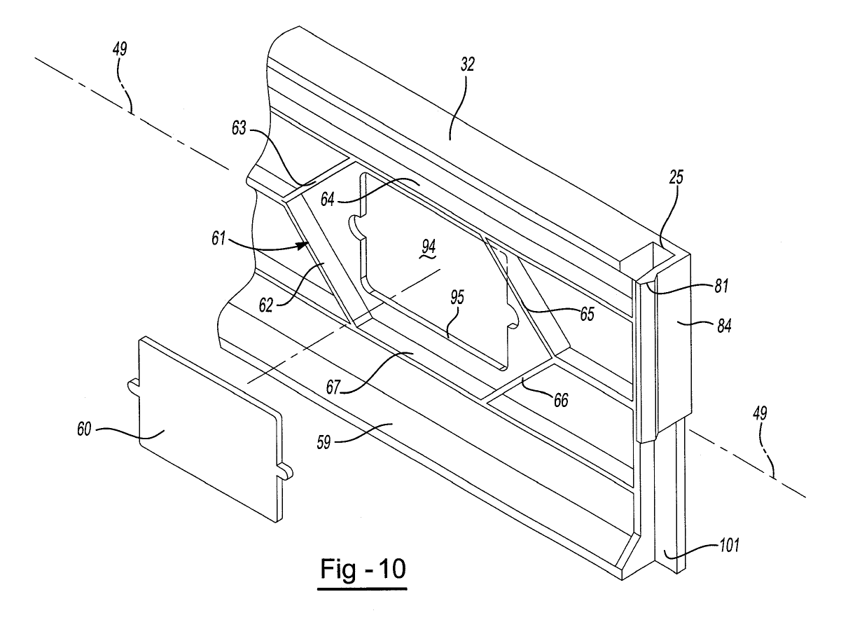

Referring to FIG. 2, a partially-broken isometric view is shown of back sides 47 of adjacent kick panels prior to being installed in a shelving unit. Each kick panel has lateral, longitudinal and vertical axes, 48, 49, 50, respectively. Longitudinal axis 49 and vertical axis 50 form an imaginary plane substantially coincident with the panel. A plurality of vertical and horizontal stiffening ribs, 51-55 and 56-58, respectively, to strengthen the kick plate and lessen possible damage from impact are shown. Each kick plate 30 also has a lower shelf 59. The ribs may be spaced substantially uniformly with respect to an axis they are parallel to. In FIG. 2, for example, horizontal ribs 56-58 are spaced substantially uniformly with respect to longitudinal axis 49. Alternatively, the ribs may be spaced nonuniformly with respect to an axis they are parallel to. For example, vertical ribs 51-55 are spaced nonuniformly with respect to vertical axis 50. The kick panels may also include break-out panel portion 60, which may be readily removed from the panel to facilitate installation of an electrical outlet box. Alternatively, portion 60 may be left in place when there is no need for an electrical outlet box, and a substantially smooth front face 31 for the panel is desired. Substantially hexagon-shaped arrangement of strengthening ribs 61 around break-out panel portion is shown in FIG. 2. Hexagon-shaped arrangement of ribs 61 also strengthens the kick plate and lessens possible damage from impact. Furthermore, angled ribs 62, 63, 65, 66, of hexagon-shaped arrangement of ribs 61 provide additional strength to prevent damage from increased loading and unloading of this region of the panel due to plugging and unplugging wires with respect to the electrical outlet box. Rib 64 is coincident with horizontal rib 58. Rib 67 is coincident with horizontal rib 56. The above elements are shown in greater detail in FIG. 10.

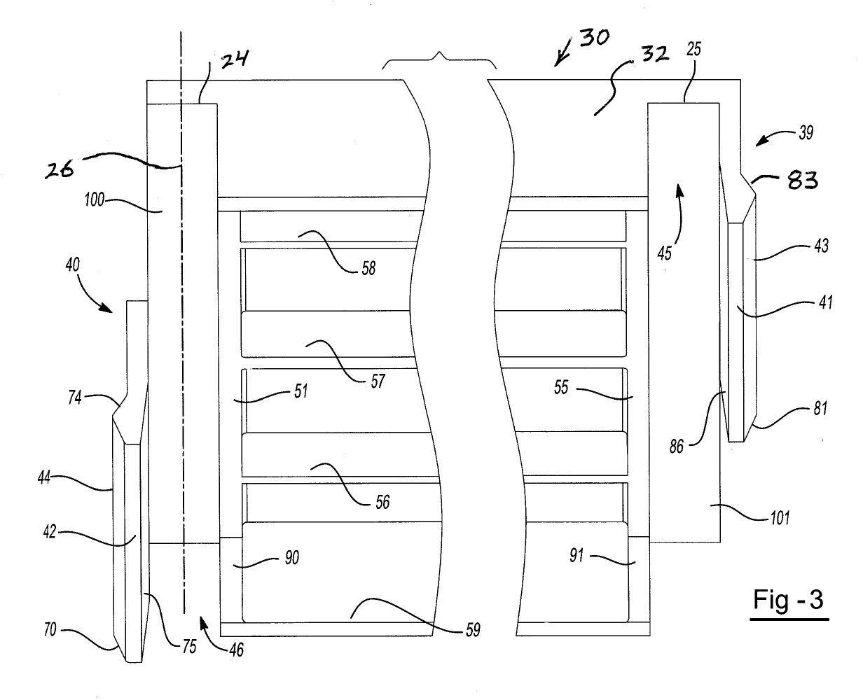

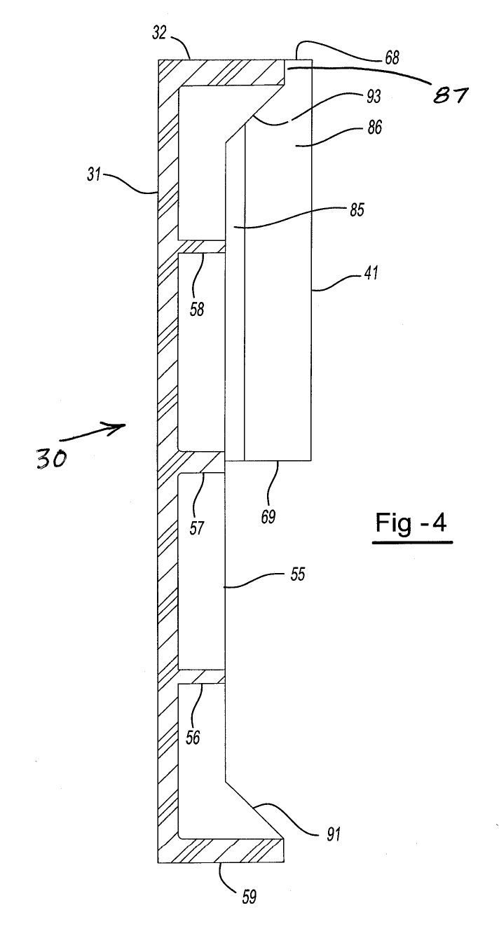

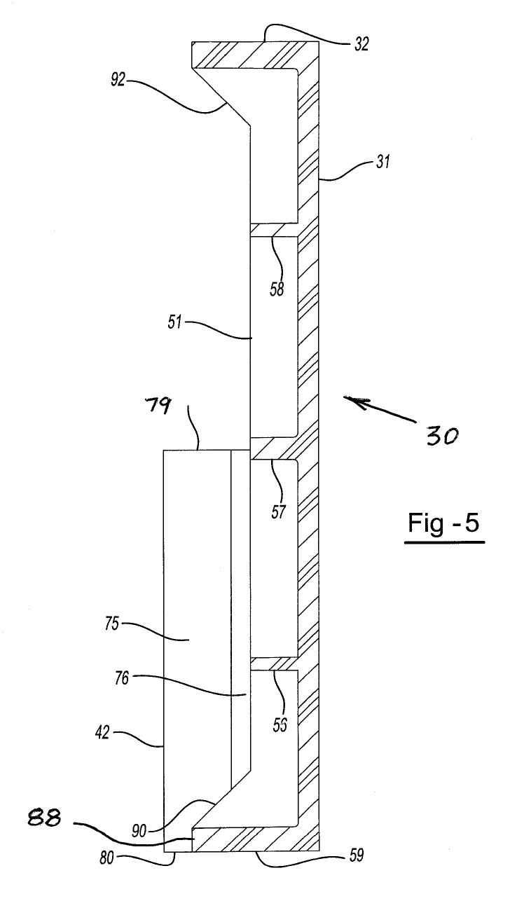

Referring to FIG. 3, a broken elevated view of the ends of kick panel 30 is shown. Horizontal stiffening ribs 56-58 extend from vertical stiffening ribs 51 and 55, substantially parallel to the longitudinal axis. Upper and lower shelves 32, 59, respectively, extend between vertical stiffening ribs 51 and 55, substantially parallel to the vertical axis. Stiffening gusset 90 extends between vertical rib 51 and lower shelf 59. Stiffening gusset 91 extends between vertical rib 55 and lower shelf 59. The left and right ends have substantially L-shaped members 39, 40, respectively, projecting from them. L-shaped member 39 and vertical rib 55 together form channel 45. The bottom of channel 45 is shown at reference sign 25. L-shaped member 40 and vertical rib 51 together form channel 46. Each L-shaped member has a longitudinal axis, for example, as shown at reference number 26. The longitudinal axes of the L-shaped members may be parallel with the vertical axis of the panel. Lip 43 may extend along substantially the entire vertical height of L-shaped member 39, i.e. substantially the entire vertical height between edge 68 and edge 69 in FIG. 4. Lip 43 may be substantially parallel to the longitudinal axis (not shown) of the L-shaped member. Lip 44 may extend along substantially the entire vertical height of L-shaped member 40, i.e. substantially the entire vertical height between edge 79 and edge 80 in FIG. 5. Lip 44 may be substantially parallel to longitudinal axis 26. Distal end 41 of L-shaped member 39 extends substantially past the edge of lower shelf 59. Distal end 42 of L-shaped member 40 extends substantially past the edge of lower shelf 59. Distal end 41 includes lip 43 between leading edge 81 and trailing edge 83, which face away from the vertical axis of panel 32. Distal end 42 includes lip 44 between leading edge 70 and trailing edge 74, which also face away from the vertical axis of panel 32. Distal end 41 further includes lead-in surface 86, which faces toward the vertical axis of panel 32. Distal end 42 further includes lead-in surface 75, which also faces toward the vertical axis of panel 32. L-shaped member 39 may include channel bottom extension 101. Extension 101 may be formed integrally with channel bottom 25 of channel 45, panel front face 31, or both. Extension 101 may be used to cover portions of vertical surface 18 which would otherwise be visible after the kick panel is installed on the base bracket. L-shaped member 40 may include channel bottom extension 100. Extension 100 may be formed integrally with the channel bottom of channel 46, panel front face 31 (as shown at reference number 24), or both. Extension 100 may be used to cover portions of vertical surface 17 which would otherwise be visible after the kick panel is installed on the base bracket.

Referring to FIG. 4, a section view taken along line 4-4 in FIG. 2 is shown. Panel 30 has upper shelf 32 and lower shelf 59. Horizontal stiffening ribs 56-58 extend to vertical stiffening rib 55, substantially parallel to the longitudinal axis. Stiffening gusset 91 extends between vertical rib 55 and lower shelf 59. Stiffening gusset 93 extends between vertical rib 55 and upper shelf 32. Distal end 41 of L-shaped member 39 may extend past edge 87 of upper shelf 32 (in a direction away from front face 31).

Referring to FIG. 5, a section view taken along line 5-5 in FIG. 2 is shown. Panel 30 has upper shelf 32 and lower shelf 59. Horizontal stiffening ribs 56-58 extend to vertical stiffening rib 51, substantially parallel to the longitudinal axis. Stiffening gusset 90 extends between vertical rib 51 and lower shelf 59. Stiffening gusset 92 extends between vertical rib 51 and upper shelf 32. Distal end 42 of L-shaped member 40 may extend past edge 88 of lower shelf 59 (in a direction away from front face 31).

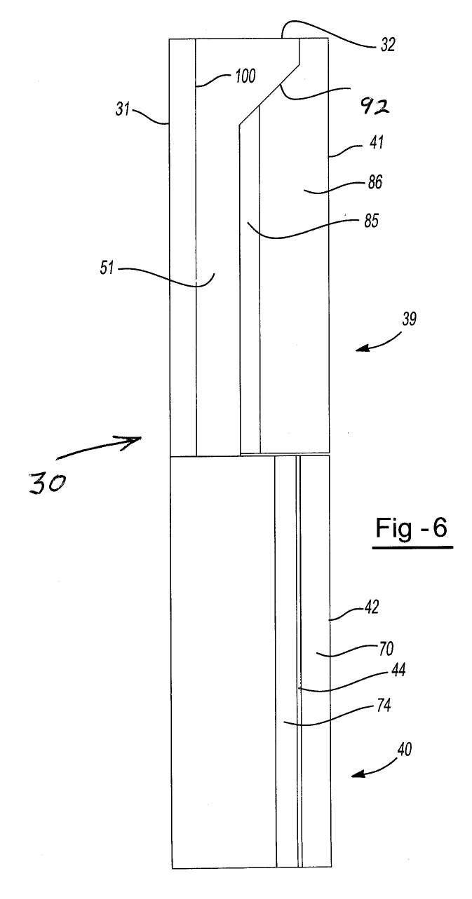

Referring to FIG. 6, a side view of the right end of the kick panel in FIG. 2 is shown. Panel 30 has front face 31 and upper shelf 32. Stiffening gusset 92 extends between vertical rib 51 and upper shelf 32. L-shaped member 39 has distal end 41 with lead-in surface 86. L-shaped member 40 has distal end 42 with lip 44 between leading edge 70 and trailing edge 74. L-shaped member 40 also has channel bottom extension 100, which extends to upper shelf 32.

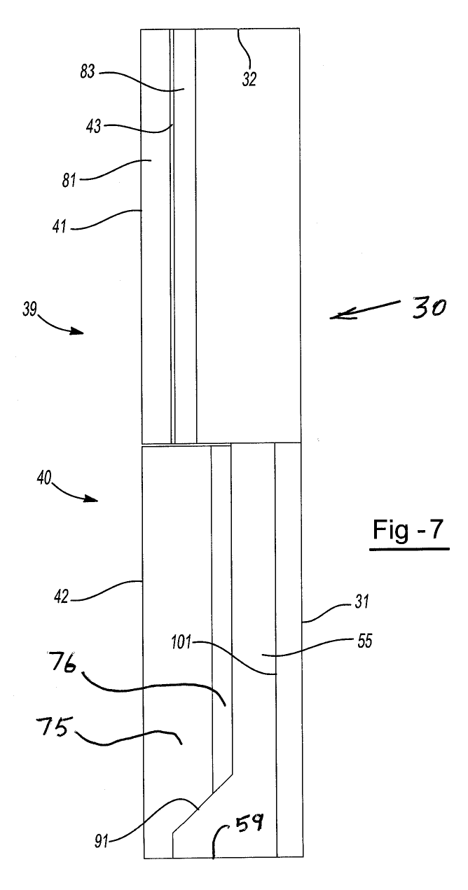

Referring to FIG. 7, a side view of the left end of the kick panel in FIG. 2 is shown. Panel 30 has front face 31 and upper shelf 32. Stiffening gusset 91 extends between vertical rib 55 and lower shelf 59. L-shaped member 40 has distal end 42 with lead-in surface 75. L-shaped member 39 has distal end 41 with lip 43 between leading edge 81 and trailing edge 83. L-shaped member 40 also has channel bottom extension 101, which extends to lower shelf 59.

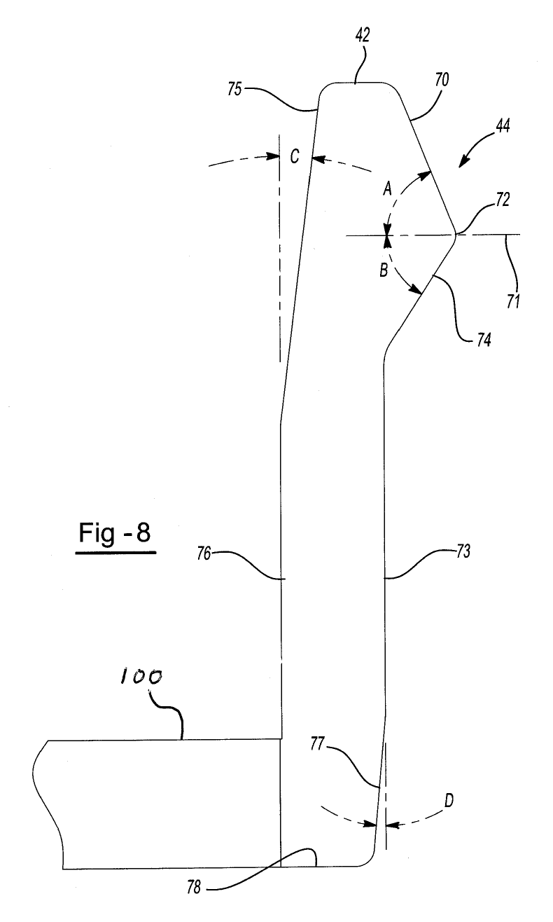

Referring to FIG. 8, a top view of right L-shaped member 40 having distal end 42 is shown. Lip 44 may form a substantially triangular projection comprising leading edge 70 and trailing edge 74. When kick panel 30 is ready to be assembled with base bracket 10 of a shelving unit, distal end 42 of L-shaped bracket 40 is first aligned with vertical gap 21 of the base bracket. The objective is to apply a substantially normal force to front face 31 in the region of reference number 78. The normal force must be sufficient to cause distal end 42 to move through vertical gap 21 until lip 44 becomes removably secured within vertical opening 22. As distal end 42 “splits the gap” (i.e. vertical gap 21), bracket portions 15 and 16 will substantially elastically deflect in opposite directions, thus permitting distal end to proceed further into the gap and towards vertical opening 22. First angle A facilitates beginning this process of deflection for bracket portion 16, as compared to a distal end that is substantially rectangular. Furthermore, lead-in surface 75 also facilitates beginning this process of deflection for bracket portion 15, as compared to a distal end that is substantially rectangular. Lead-in surface 75 may form lead-in angle C with respect to inner side 76 of L-shaped member 40. Lead-in angle C may be about 5 to about 10 degrees. Alternatively, lead-in angle C may be about 7 degrees. Furthermore, having lead-in surface 75 and leading edge 70 at angles (instead of a distal end that is substantially rectangular) forces the metal of brackets 11, 12, to be displaced less, which will extend the life of brackets 11, 12, as kick plates are removed and installed multiple times. Furthermore, having lead-in surface 75 and leading edge 70 at angles makes both brackets 11, 12, work (i.e. flex), as opposed to just one of the brackets, which would be the case if only one was at an angle. Furthermore, the kick panel is able to flex, in order to facilitate alignment and installation of the distal end in vertical opening 22.

Line 71 passes through peak 72 of the triangular projection and is substantially perpendicular to outer side 73 of L-shaped member 40. Peak 72 may project away from outer side 73. Leading edge 70 of lip 44 may form first angle A with respect to line 71. Furthermore, leading edge 70 may form first angle A of between about 65 and 70 degrees with respect to line 71. Furthermore, leading edge 70 may form first angle A of about 68 degrees with respect to line 71. Trailing edge 74 of lip 44 may form second angle B with respect to line 71. Furthermore, trailing edge 74 may form second angle B of between about 55 and 60 degrees with respect to line 71. Furthermore, trailing edge 74 may form second angle B of about 57 degrees with respect to line 71. First angle A may be greater than second angle B. This provides the benefit of initially being able to more easily begin the process of inserting the distal end into the base bracket, but also making it more difficult for the distal end to become dislodged from the vertical opening when unintended removal of the panel begins to occur. In other words, slipping the distal end into the base bracket for installation is made easier by the geometries described herein. At the same time, the holding power of the lip is improved by trailing surface 74 being of the geometries described herein. Trailing surface 74 may be formed so as to be substantially parallel to, or match, triangular channels 13, 14, in order to maximize the holding power of the lip. Leading edge 70 of lip 44 may form a third interior angle with respect to trailing edge 74 of between about 120 degrees and 130 degrees. Furthermore, leading edge 70 may form a third interior angle with respect to trailing edge 74 of about 125 degrees.

Angled surface 77 may form angle D with respect to outer side 73 of L-shaped member 40. Angle D may be about 3 to about 7 degrees. Alternatively, angle D may be about 5 degrees. The purpose of angle D is to simplify construction of plastic injection molds, as well as fabrication of the polymer kick panels, i.e. to ease their release from the molds during production. Panel 30 may comprise a polymer panel. Furthermore, panel 30 may comprise a high-density polyethylene (HDPE) panel. Furthermore, panel 30 may comprise a “six melt” high-density polyethylene (HDPE) panel. Furthermore, panel 30 may comprise a metal panel.

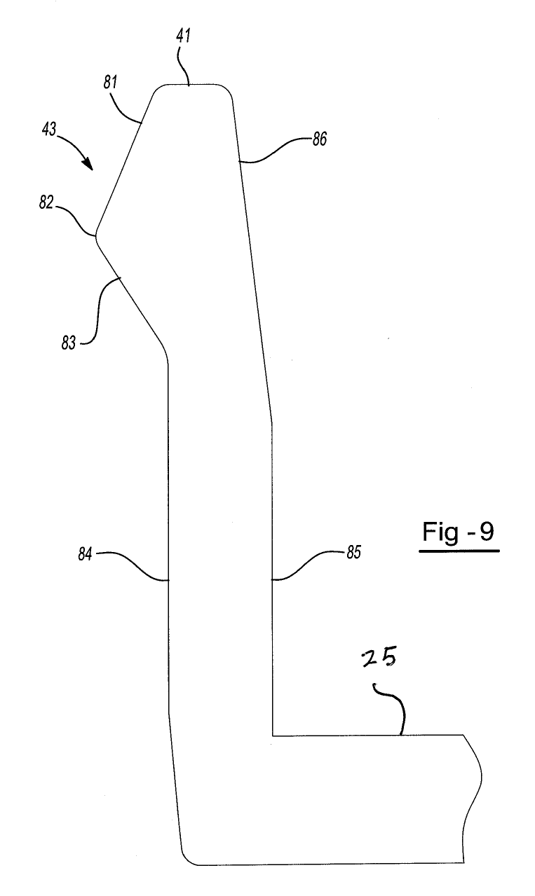

Referring to FIG. 9, a top view of left L-shaped member 39 having distal end 41 is shown. Lip 43 may form a substantially triangular projection comprising leading edge 81 and trailing edge 83, as well as peak 82. The L-shaped member has outer surface 84, inner surface 85 and lead-in surface 86. The relationships and functions of these elements parallels those described above (in particular, for FIG. 8).

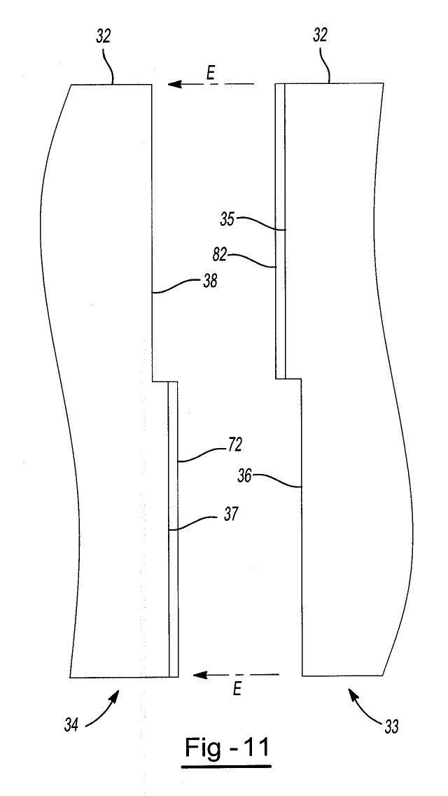

Referring to FIG. 11, a broken front view is shown of the front sides of adjacent ends of kick panels 33, 34, prior to being installed in a shelving unit. The adjacent panels may substantially adjoin and substantially butt together as end 33 is moved in direction E during installation of the kick panels in a base bracket of a shelving unit.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof.

Therefore, it is intended that the invention not be limited to the particular embodiment disclosed as the best mode contemplated for carrying out this invention, but that the invention will also include all embodiments falling within the scope of the following claims.

1. A kick plate for a base bracket of a shelving unit, comprising:
an elongated panel having longitudinal and vertical axes, and an imaginary plane substantially coincident with the panel; and
a substantially L-shaped member projecting from an end of the panel and integral with the panel, the L-shaped member having a longitudinal axis substantially parallel to the panel vertical axis, the L-shaped member further having a distal end extending further from the plane than the horizontal surfaces past the nominal width of the panel, wherein the distal end has a lip, wherein the lip removably attaches the panel to the shelving unit after the L-shaped member is inserted into the base bracket of the shelving unit;
wherein the panel is removably attachable to the base bracket.

2. The kick plate of claim 1, wherein the lip is a substantially triangular projection extending along substantially the length of the L-shaped member, wherein the peak of the triangular projection is substantially parallel to the device longitudinal axis.
